(19) United States
(12) Patent Application Publication
(10) Pub. No.: US 2005/0000256 A1
(43) Pub. Date: Jan. 6, 2005

(54) Theft deterrent device

(76) Inventors: Larry R. Yeager, Uniontown, OH (US); Frank H. Copen, Shreve, OH (US); David Hayes, Wooster, OH (US); Stephen P. Casteel, Canal Fulton, OH (US)

Correspondence Address: SAND & SEBOLT, AEGIS TOWER, SUITE 1100, 4940 MUNSON STREET, NW, CANTON, OH, 44718-3615, US

(21) Appl. No.: 10/613,060

(22) Filed: Jul. 2, 2003

(51) Int. Cl. E05B 65/00

(52) U.S. Cl. 70/57.1

(57) ABSTRACT

A theft deterrent device that can be securely connected to an item of merchandise includes a U-shaped clasp that selectively locks within a housing having a base and a hinged lock member. The lock member is movable between unlocked and locked positions with the locked position of the locked member securely locking the end of the clasp within the housing so that it cannot be removed until a specially designed key is used to unlock the lock member from the housing. The lock member engages the end of the clasp in at least two directions on two different sides to form a secure locking arrangement.

### BACKGROUND OF THE INVENTION

1. Technical Field

The present invention generally relates to theft deterrent devices or anti-shoplifting devices. More particularly, the present invention relates to a benefit denial-type of theft deterrent device that locks onto the item of merchandise being protected so that the shoplifter must take extra efforts to remove the theft deterrent device from a shoplifted item. Specifically, the present invention relates to a type of theft deterrent device that clamps onto an item of merchandise in a manner that prevents the theft deterrent device from being easily removed.

2. Background Information

Numerous types of theft deterrent devices are known in the art. One class of theft deterrent devices carries an electronic article surveillance (EAS) tag and allows the EAS tag to be secured to an item of merchandise. Another class of theft deterrent devices simply locks onto a portion of the item of merchandise in a manner that makes it very difficult for a shoplifter to remove the theft deterrent device. This class of theft deterrent devices does not carry an EAS tag. They simply annoy the shoplifter and force the shoplifter to take difficult steps to remove the theft deterrent device from the item of merchandise. These steps often result in damage to the item of merchandise thus eliminating the benefit of the theft.

One growing area for these types of theft deterrent devices is with smaller items of merchandise such as electronics and jewelry. Retailers generally do not wish to hide these small items of merchandise behind a locked cabinet because locked cabinets require employee attendants and discourage shoppers from browsing. Retailers are also generally reluctant to add large bulky theft deterrent devices to relatively small items of merchandise because large bulky theft deterrent devices can detract from the purchasing or browsing experience by the consumer.

### SUMMARY OF THE INVENTION

The invention provides a theft deterrent device that can be securely connected to an item of merchandise. The theft deterrent device of the invention includes a U-shaped clasp that fits within a housing having a base and a hinged lock member. The lock member is movable between unlocked and locked positions. The locked position of the locked member securely locks the end of the clasp within the housing where it can not be removed until a key is used to unlock the lock member from the housing.

The invention also provides a lock clasp and housing having lock teeth that engage on at least two sides of the clasp to securely lock the clasp within the housing.

The invention also provides a theft deterrent device that is relatively small and compact while being relatively difficult to destroy without damaging the item of merchandise secured by the theft deterrent device.

### BRIEF DESCRIPTION OF THE SEVERAL VIEWS OF THE DRAWINGS

FIG. 1 is a top plan view of the theft deterrent device of the invention connected to an item of merchandise.

FIG. 2 is a left side elevation view of FIG. 1.

FIG. 3 is an exploded view that is partially in section showing the clasp detached from the housing.

FIG. 4 is a view similar to FIG. 3 showing the clasp inserted into the housing.

FIG. 5 is a bottom plan view of the lock member detached from the housing.

FIG. 6 is a section view taken along line 6-6 of FIG. 3 with the lock member of the theft deterrent device in an unlocked position.

FIG. 7 is a section view taken along line 7-7 of FIG. 4 showing the lock member in the locked position.

FIG. 8 is an enlarged view of the encircled portion of FIG. 4.

FIG. 9 is an enlarged view of the encircled portion of FIG. 7.

FIG. 10 is a section view taken along line 10-10 of FIG. 4 showing the wedges of the locking member engaging the wedges of the clasp.

FIG. 11 is an enlarged view of the encircled portion of FIG. 10.

Similar numbers refer to similar parts throughout the specification.

### DETAILED DESCRIPTION OF THE INVENTION

The theft deterrent device of the present invention is indicated generally by the numeral 10 in the accompanying drawings. Theft deterrent device 10 is used by retailers to protect various items of merchandise 12 from shoplifters. Device 10 functions by being securely clamped or locked to item of merchandise 12 so that a successful shoplifter will be forced to spend time and effort to remove theft deterrent device 10 before reselling the shoplifted item. The embodiment of theft deterrent device 10 depicted in the drawings does not carry an EAS tag. Other embodiments of the invention may be configured to provide a chamber to hold an EAS tag if the cost of providing the EAS tag justifies adding the EAS tag to device 10.

Theft deterrent device 10 generally includes a housing 20 and a clasp 22. Clasp 22 may be selectively locked to housing 20 in a manner wherein clasp 22 can only be unlocked and removed from housing 20 with a specially designed key. In the exemplary embodiment of the invention depicted in the drawings, clasp 22 is generally U-shaped. Clasp 22 thus includes a bridge 24 and a pair of spaced locking legs 26. Housing 20 generally includes a base 28 and a lock member 30 that is movable with respect to base 28 between unlocked and locked positions. In the exemplary embodiment of the invention, lock member 30 is hinged with respect to base 28. Lock member 30 is connected to base 28 with an appropriate hinge 32. A lock 34 is carried by housing 20 and is adapted to retain lock member 30 in the locked position. In another embodiment, lock member 30 may slide between the locked and unlocked positions. Lock member 30 may be removable instead of pivoting.

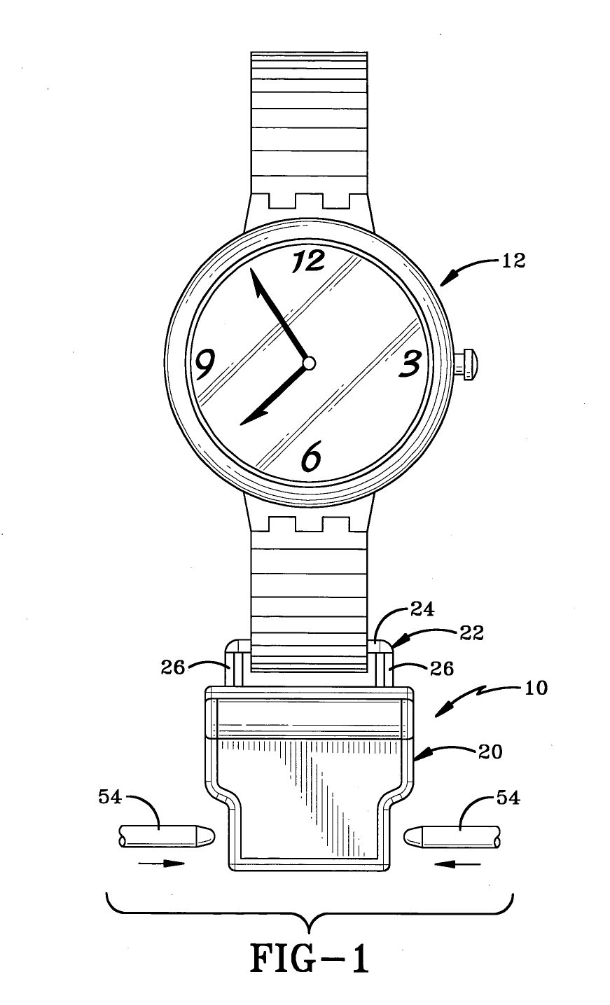

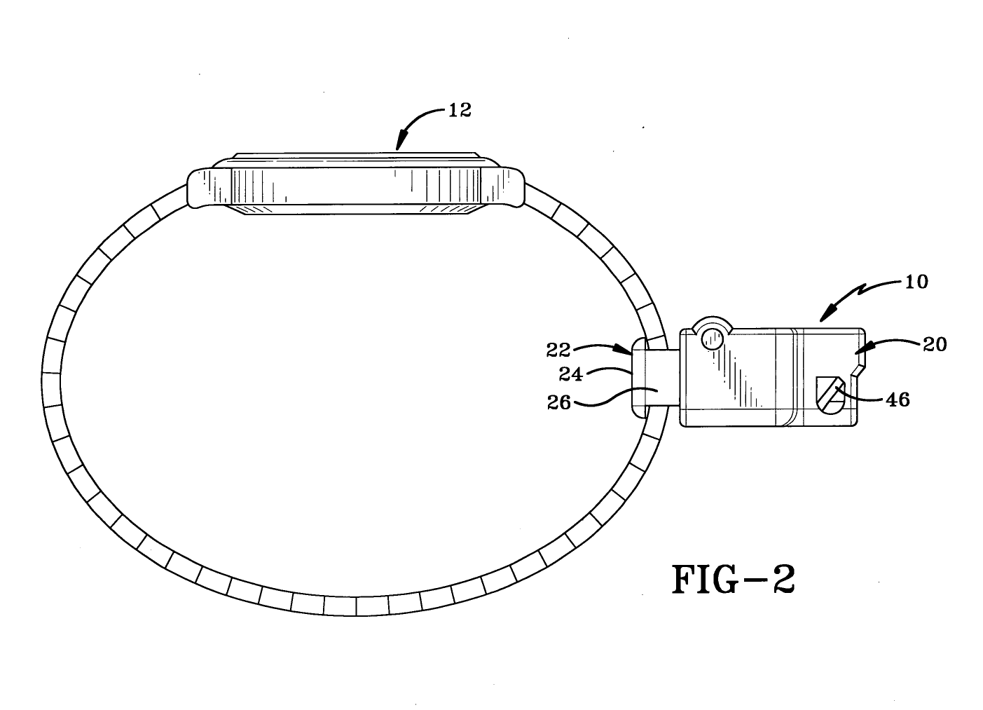

Lock 34 generally includes at least one lock finger 40 and a corresponding locking ledge 42. In the exemplary embodiment of the invention, lock 34 includes a pair of spaced lock fingers 40 and a pair of spaced lock ledges 42 on which lock fingers 40 engage. Each lock finger 40 includes a first leg 44 extending substantially perpendicular from lock member 30 as depicted in FIG. 6. A second leg 46 extends from the distal end of first leg 44. The distal end of second leg 46 is configured to engage and lock against lock ledge 42 when lock member 30 is moved to the locked position as depicted in FIG. 7. Second leg 46 is thus angled upwardly back towards lock member 30 from the distal end of first leg 44. Lock ledge 42 may extend entirely across the width of base 28 or may be provided in two separate spaced locations. Base 28 includes two opposed side walls 50 that each define a key opening 52 that is adapted to receive a key pin 54 (as shown schematically in FIG. 1) to engage second leg 46 and force lock fingers 40 out of engagement with lock ledges 42 to open lock member 30. The relative angle of second leg 46 with respect to base 28 forces lock member 30 to the unlocked position when key pin 54 is disposed within base 28. A security feature of device 10 is that two key pins 54 must be inserted into base 28 in opposite directions at the same time in order to unlock lock 34.

Each locking leg 26 of clasp 22 includes at least one set of locking teeth 60 that are adapted to lockingly engage at least one set of locking teeth 62 carried by housing 20. Teeth 60 and 62 are adapted to engage each other in a locked condition when lock member 30 is in the locked position such that clasp 22 cannot be pulled from housing 20. As such, each tooth 60 or 62 includes an angled surface and a flat surface with the flat surfaces being disposed to engage and hold each other when device 10 is locked.

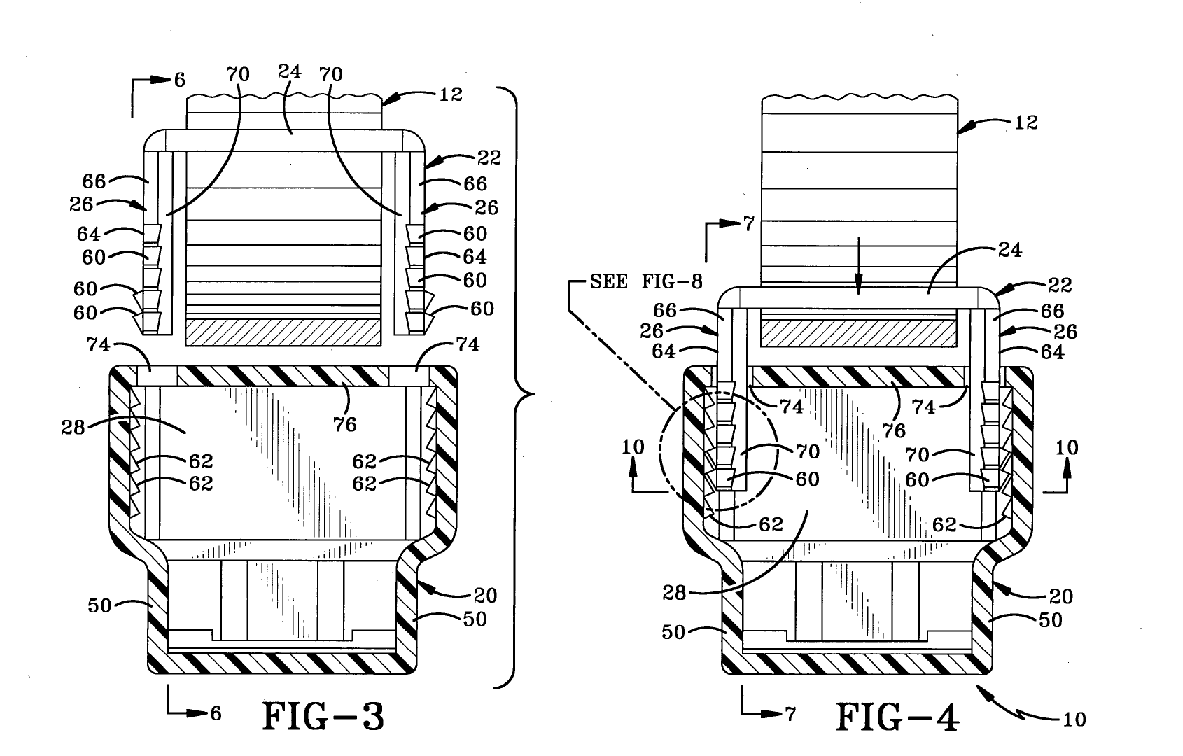

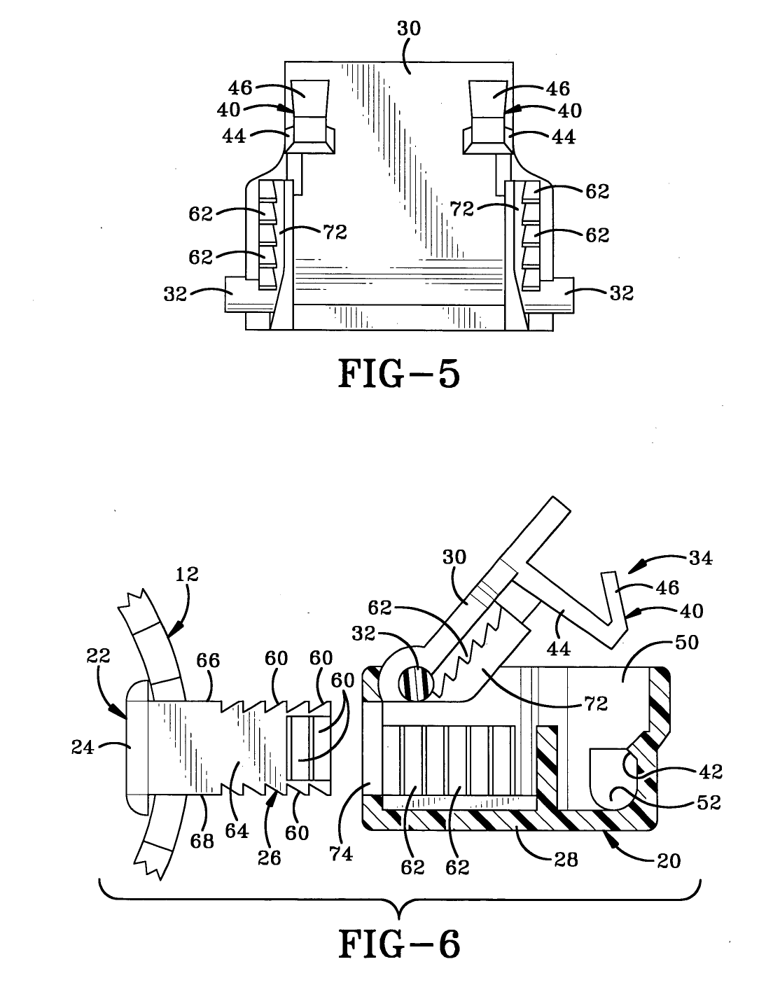

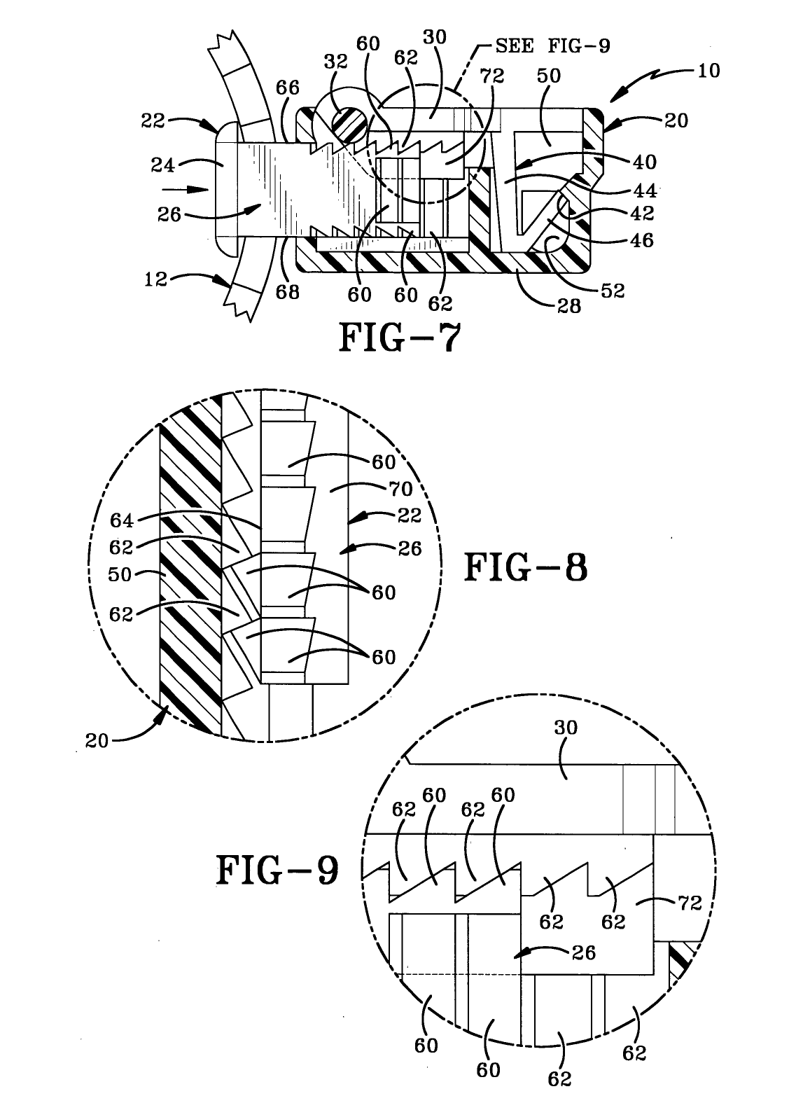

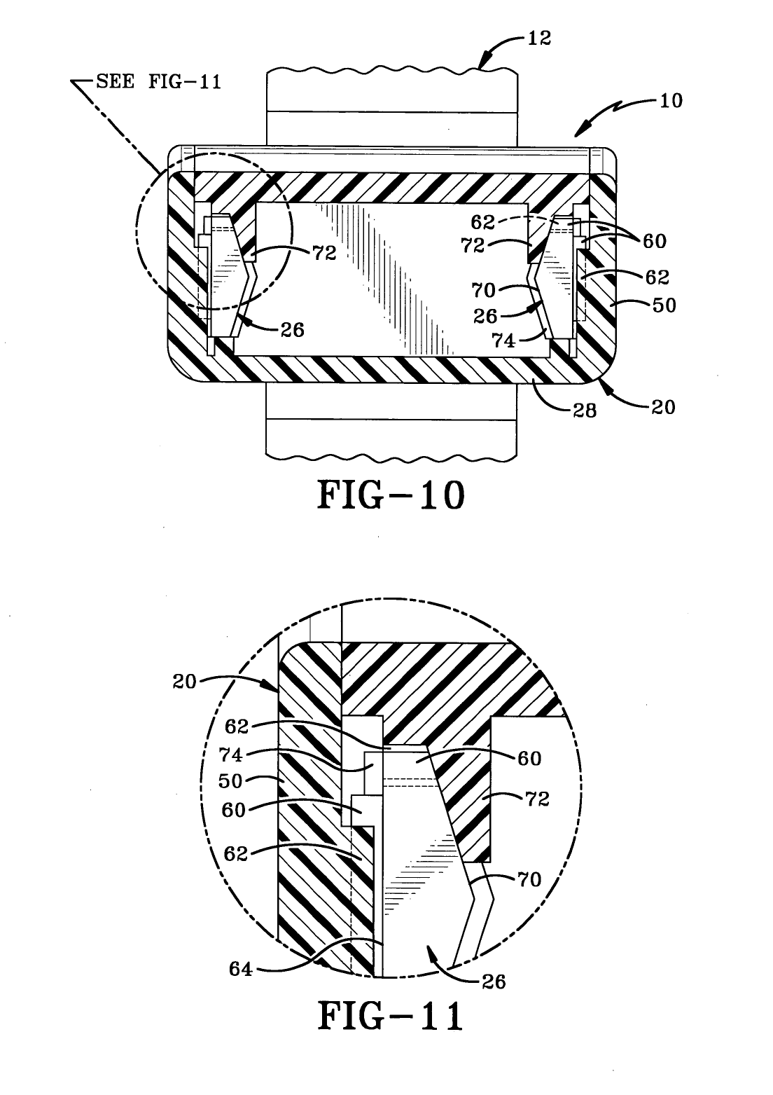

Each locking leg 26 of clasp 22 includes locking teeth 60 along its outer surface 64 and along at least one edge 66. Teeth 60 disposed along surface 64 and edge 66 provide a lock in at least two directions when clasp 22 is locked to housing 20. Locking teeth 60 are also disposed along edge 68 in order to make clasp 22 symmetric so that it may be inserted into housing 20 with either locking leg 26 disposed on either side of housing 20. The inner surface 70 (FIGS. 3 and 10) of each locking leg 26 is wedge-shaped. Inner surface 70 is configured to be engaged by a wedge 72 extending from lock member 30 when lock member 30 is moved down into the locked position as shown in FIGS. 10 and 11. Wedge 72 engages inner surface 70 and forces locking legs 26 outwardly into teeth 62 to provide a secure locked connection between clasp 22 and housing 20.

Theft deterrent device 10 is thus used by unlocking lock member 30 of housing 20 and removing clasp 22 from housing 20. Clasp 22 is then placed around item of merchandise 12 and locking legs 26 are aligned with the leg-receiving openings 74 defined by the front wall 76 of base 20. The user then pushes clasp 22 into housing 20 causing locking teeth 60 on outer surfaces 64 to ride against and snap fit with locking teeth 62 that project inwardly from sidewalls 50 as shown in FIGS. 3 and 4. Once clasp 22 is inserted the desired distance into housing 20, the user closes lock member 30 from its unlocked position (FIG. 6) to its locked position (FIG. 7) causing wedges 72 to drive locking legs 26 outwardly into sidewalls 50 as depicted in FIGS. 10 and 11. Locking teeth 62 that project down from lock member 30 (FIG. 6) then engage locking teeth 60 that project upwardly from edge 66 as depicted in FIG. 7. Lock member 30 is depressed to the locked position until lock 34 is in the locked position as depicted in FIG. 7. In this position, clasp 22 is securely held in position by the engagement of two separate sets of locking teeth 60/62 as well as the force of wedges 72 against inner surfaces 70. A shoplifter would thus find it time consuming and difficult to remove clasp 22 from housing 20 without damaging item 12.

Housing 20 is wider at the clasp end than the key pin end such that housing 20 may only be inserted into a key in one direction. The different widths can be seen in FIG. 4.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A theft deterrent device, comprising;
a housing and a clasp;
a clasp being removably and lockingly received in the housing;
the housing including a wedge moveable between unlocked and locked positions; the wedge engaging the clasp in the locked position to force a portion of the clasp against the housing when the clasp is locked to the housing.

2. The device of claim 1, wherein the clasp is U-shaped and locks to the housing in two spaced locations.

3. The device of claim 1, wherein the clasp includes a pair of locking legs connected together by a bridge.

4. The device of claim 3, wherein each of the locking legs includes an outer surface, an inner surface, and a pair of opposed edges.

5. The device of claim 4, wherein each of the locking legs defines locking teeth along the outer surface and at least one of the edges.

6. The device of claim 5, wherein each of the locking legs defines locking teeth along both of the edges.

7. The device of claim 5, wherein the inner surface of each locking leg is wedge-shaped; the wedge of the housing being adapted to engage the inner surface of the locking leg when the clasp is locked to the housing.

8. The device of claim 1, wherein the housing includes a base, a lock member, and a lock adapted to lock the lock member in a locked position with respect to the base.

9. The device of claim 8, wherein the lock includes at least one finger and at least one lock ledge; the lock finger lockingly engaging the lock ledge.

10. The device of claim 9, wherein the housing includes a pair of opposed sidewalls that define key pin openings; at least one of the key pin openings providing access to one of the lock fingers.

11. The device of claim 8, wherein the lock member is connected to the base with a hinge.

12. The device of claim 8, wherein the wedge is connected to the lock member.

13. The device of claim 1, wherein a portion of the clasp is disposed between the wedge and the housing when the clasp is locked and when the wedge is in the locked position.

14. A theft deterrent device comprising:
a housing having a base, a lock member, and a lock that locks the lock member in a locked position with respect to the base;
the base of the housing defining lock teeth;
the lock member including a wedge;
the lock member pivoting with respect to the base between the locked position and an unlocked position;
a clasp having opposed legs, each of the legs having a wedge-shaped inner surface;
each of the legs defining lock teeth;
the legs of the clasp insertable into the housing when the lock member is in the unlocked position; and
the wedge of the lock member engaging at least one of the inner surfaces of the clasp legs when the lock member is moved to the locked position to force the lock teeth of the clasp into locked engagement with the lock teeth of the base.

15. The device of claim 14, wherein each leg of the clasp has an outer surface; the lock teeth extending from the outer surface.

16. The device of claim 15, where each leg has upper and lower edges; each defining lock teeth along the upper and lower edges of the leg such that the clasp may be inserted into the base in two orientations.

17. The device of claim 14, wherein the position of the clasp is adjustable with respect to the base.

18. The device of claim 14, wherein the clasp is removable from the housing when the lock member is in the unlocked position.

19. A theft deterrent device comprising:
a housing having a base, a lock member, and a lock that locks the lock member in a locked position with respect to the base; the lock being unlockable with a key to release the lock member from the locked position so that the lock member may be moved to an unlocked position with respect to the base;
the base of the housing defining lock teeth;
the lock member including a wedge;
the lock member being movable with respect to the base between the locked position and an unlocked position;
a clasp having opposed legs, each of the legs having a wedge-shaped surface;
each of the legs defining at least one lock tooth;
the legs of the clasp being insertable into the housing when the lock member is in the unlocked position; and
the wedge of the lock member engaging at least one of the wedge-shaped surfaces of the clasp legs when the lock member is moved to the locked position to force the at least one lock tooth of the clasp into locked engagement with the lock teeth of the base of the housing to lock the clasp in position with respect to the housing.
